(19) United States
(12) Patent Application Publication
(10) Pub. No.: US 2025/0076821 A1
(43) Pub. Date: Mar. 6, 2025

(54) MODULE AND ELECTRONIC TIMEPIECE

(71) Applicant: CASIO COMPUTER CO., LTD., Tokyo (JP)

(72) Inventor: Ryoichi KUNIMI, Tokyo (JP)

(73) Assignee: CASIO COMPUTER CO., LTD., Tokyo (JP)

(21) Appl. No.: 18/819,037

(22) Filed: Aug. 29, 2024

(30) Foreign Application Priority Data
Aug. 31, 2023 (JP) 2023-140643

(51) Int. Cl. G04D 3/00; G04B 19/247

(52) U.S. Cl. CPC G04D 3/0048; G04B 19/247

(57) ABSTRACT

A module includes a plate and a sheet-like component. The sheet-like component is a first sheet-like component or a second sheet-like component and is fixed to the plate by an adhesive. The plate has a first marker and a second marker. The first marker indicates an adhesion position of a first adhesive for the first sheet-like component to be fixed to the plate. The second marker indicates an adhesion position of a second adhesive for the second sheet-like component to be fixed to the plate.

### REFERENCE TO RELATED APPLICATIONS

This application is based upon and claims the benefit of priority from the prior Japanese Patent Application No. 2023-140643, filed on Aug. 31, 2023, the entire contents, including the description, claims, abstract and drawings, of which are incorporated herein by reference.

### TECHNICAL FIELD

The present disclosure relates to a module and an electronic timepiece.

### DESCRIPTION OF RELATED ART

Conventionally, a timepiece is provided with markers indicating adhesion positions of double-sided adhesive tape used for fixing components. For example, in JPS 59-77094 U, there is disclosed a timepiece in which, in order that the back cover of a timepiece case is fixed to the bottom of the body of the timepiece case by double-sided adhesive tape, a concave part is formed in the bottom of the body for positioning the double-sided adhesive tape.

### SUMMARY OF THE INVENTION

According to an aspect of the present disclosure, there is provided a module including:
a plate; and
a sheet-like component that is fixed to the plate by an adhesive, the sheet-like component being a first sheet-like component or a second sheet-like component,
wherein the plate has:
   a first marker indicating an adhesion position of a first adhesive for the first sheet-like component to be fixed to the plate, and
   a second marker indicating an adhesion position of a second adhesive for the second sheet-like component to be fixed to the plate.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is an exploded perspective view of a first electronic timepiece;

FIG. 2 is a plan view showing the interior of the first electronic timepiece;

FIG. 3 is a plan view showing the interior of the first electronic timepiece;

FIG. 4 is a plan view showing the interior of the first electronic timepiece;

FIG. 5 is a plan view showing the interior of the first electronic timepiece;

FIG. 6 is a sectional view taken along line VI-VI shown in FIG. 2;

FIG. 7 is a plan view showing the interior of the first electronic timepiece redesigned;

FIG. 8 is an exploded perspective view of a second electronic timepiece;

FIG. 9 is a plan view showing the interior of the second electronic timepiece;

FIG. 10 is a plan view showing the interior of the second electronic timepiece; and

FIG. 11 is a sectional view taken along line XI-XI shown in FIG. 10.

### DETAILED DESCRIPTION

Hereinafter one or more embodiments will be described with reference to the drawings. Features and technical effects of the embodiments will be understood from the following detailed description and the drawings. However, the scope of the present disclosure is not limited to the embodiments disclosed below. The drawings are provided for illustrative purposes only, and therefore the scope of the present disclosure is not limited to the illustrated examples either.

Hereinafter ordinal numbers, such as “first” and “second”, may be attached to objects having the same name. The ordinal numbers are used only for distinguishing objects provided with the same name from one another, and not intended to limit such objects to specific objects or to specify the order, ranking, sequence, classes, priority, inferiority or the like of the objects.

### 1. ELECTRONIC TIMEPIECE SET

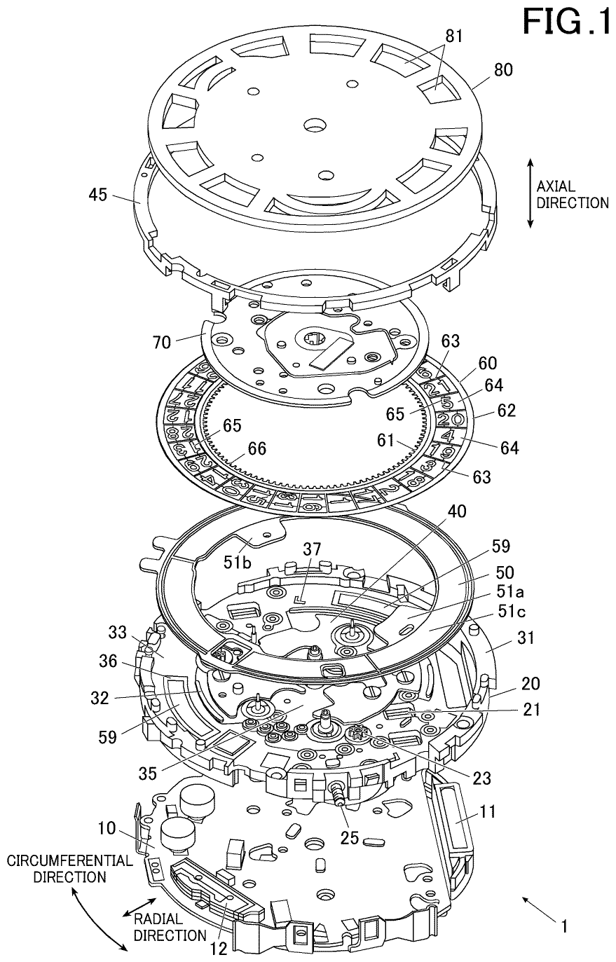

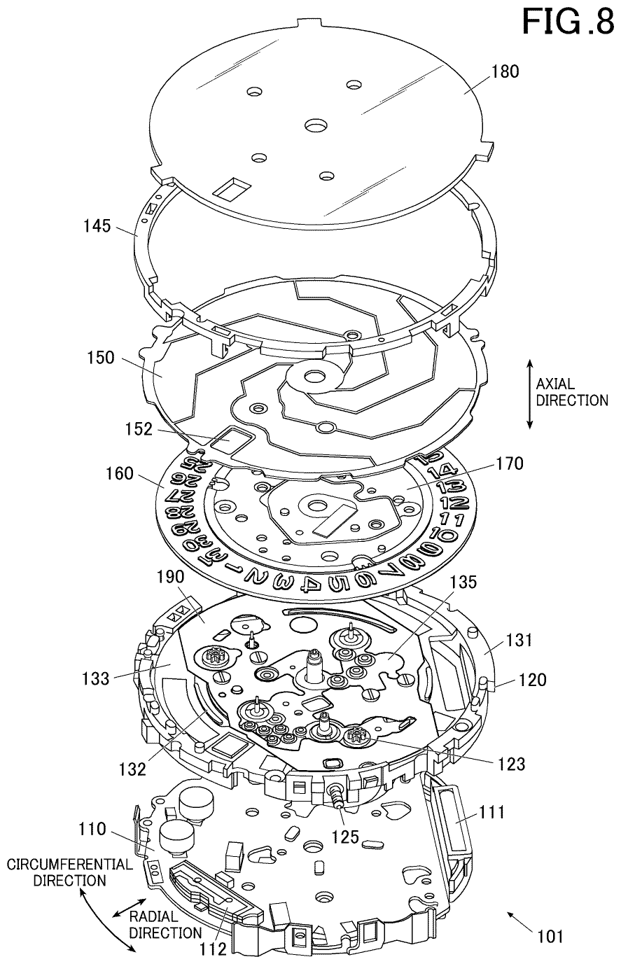

FIG. 1 is an exploded perspective view of a first electronic timepiece 1. FIG. 8 is an exploded perspective view of a second electronic timepiece 101.

The electronic timepieces 1, 101 are timepieces indicating time. The electronic timepiece 1 and the electronic timepiece 101 have a relationship of sister products and are different models. The electronic timepiece 1 and the electronic timepiece 101 have shared (identical) components and unshared (different) components. A set of an electronic timepiece 1 and an electronic timepiece 101 is referred to as an electronic timepiece set.

### 2. FIRST ELECTRONIC TIMEPIECE

The electronic timepiece 1 includes a case and a module. The module includes components shown in FIG. 1 housed in the case. The case is attached to an arm (wrist) of a user with an armband or an arm belt. The case includes a frame-shaped case body made of metal or resin, a transparent crystal made of resin or glass, and a back cover made of metal or resin. The crystal is fixed to the front of the case body to cover the hollow (opening/space) of the case body, and the back cover is fixed to the back of the case body to cover the hollow of the case body.

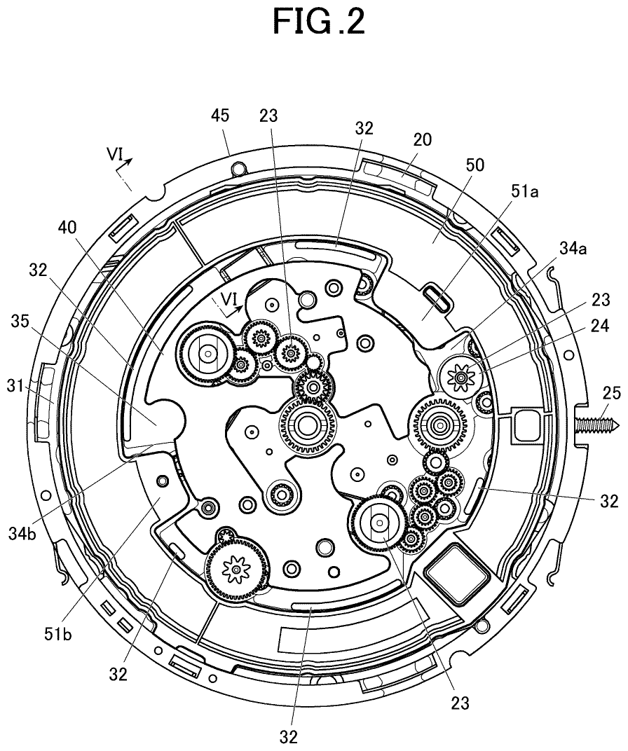

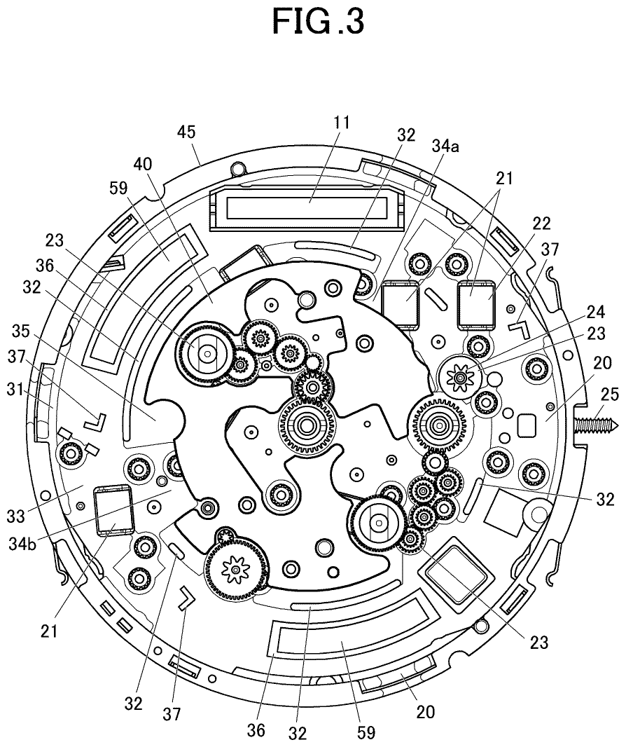

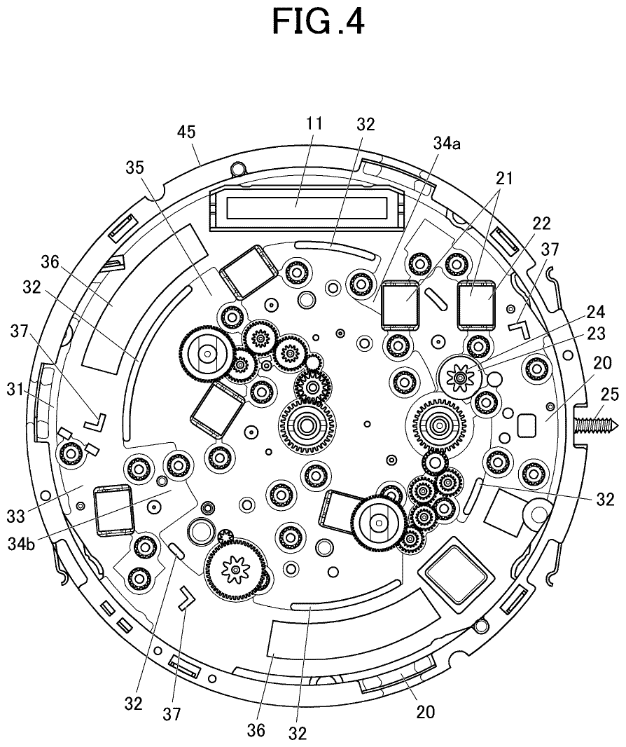

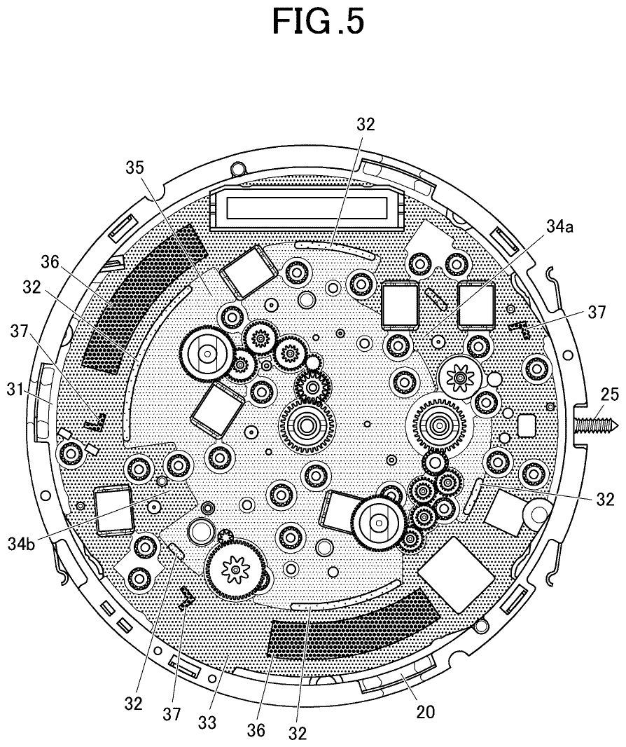

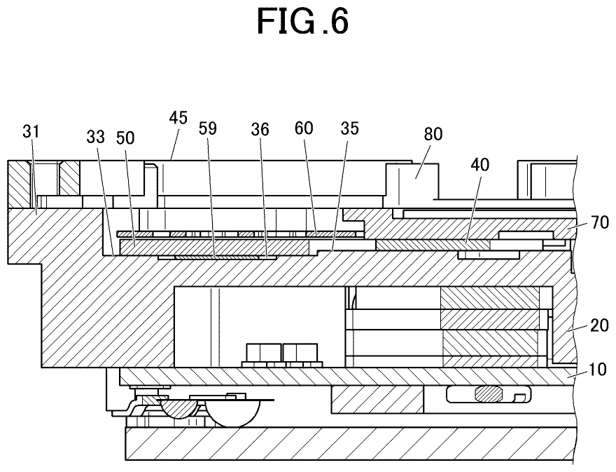

As shown in FIG. 1, the electronic timepiece 1 includes, in order from the back to the front, a circuit board 10, a main plate 20 (plate), a spacer 40, a solar panel 50 (sheet-like component, first sheet-like component), a date indicator 60, a date indicator maintaining plate 70 (hold-down member) and a dial 80 as the components of the module. An assembly of these internal components of the electronic timepiece 1 is the module. The electronic timepiece 1 (module thereof) further includes a frame 45 and a plurality of strips of double-sided adhesive tape 59 (pieces of a first adhesive). Hereinafter these internal components will be described in detail with reference to FIG. 1 to FIG. 6. FIG. 2 to FIG. 5 are plan views showing the interior of the case. FIG. 2 to FIG. 5 are plan views as the electronic timepiece 1 is viewed in the direction from the crystal toward the back cover. FIG. 2 does not show the date indicator 60, the date indicator maintaining plate 70 and the dial 80. FIG. 3 does not show the solar panel 50, the date indicator 60, the date indicator maintaining plate 70 and the dial 80. FIG. 4 and FIG. 5 do not show the spacer 40, the double-sided adhesive tape 59, the solar panel 50, the date indicator 60, the date indicator maintaining plate 70 and the dial 80. FIG. 5 shows unevenness on the front of the main plate 20 with various patterns to make the unevenness easily recognized. In the present disclosure, the front of each component of the electronic timepiece 1 (or 101) refers to a face thereof oriented toward the crystal, and the back of each component of the electronic timepiece 1 (or 101) refers to a face thereof oriented toward the back cover. FIG. 6 is a sectional view taken along line VI-VI shown in FIG. 2 as viewed in the arrow direction.

### (1) Circuit Board

The circuit board 10 has electric components mounted thereon. Examples of the electric components include an antenna 11, a transceiver 12, a light emitting element, a terminal, an integrated circuit (IC) chip and a rechargeable battery. The antenna 11 is a component for wireless communications (communication component) that receives standard radio waves for time correction. The transceiver 12 is a component for wireless communications (communication component) including an antenna, a transmitter, a receiver and a controller. As a communication standard of the transceiver 12, Bluetooth® Low Energy abbreviated as BLE, Wi-Fi®, ZigBee® or the like is employed. Because the transceiver 12 and the antenna 11 are arranged apart from one another, interference between the transceiver 12 and the antenna 11 is prevented. If positions of the antenna 11 and the transceiver 12 are expressed in clock position, the antenna 11 is arranged at twelve o'clock, and the transceiver 12 is arranged at five o'clock to six o'clock.

In place of the transceiver 12, an antenna for wireless communications conforming to a communication standard such as BLE, Wi-Fi or ZigBee may be mounted on the circuit board 10. The mounting position of the antenna is the same as that of the transceiver 12.

### (2) Main Plate

The main plate 20 is laid on the front of the circuit board 10. The shape of the main plate 20 is based on a circular plate centered on a central axis that passes through the center of the main plate 20. Hereafter the direction parallel to the central axis that passes through the center of the main plate 20 is referred to as an axial direction, the direction along a circle around the central axis is referred to as circumferential direction, and the direction along a diameter perpendicular to the central axis is referred to as a radial direction. The direction from the front toward the back of the main plate 20 and its opposite direction are parallel to the axial direction. The thickness direction of the main plate 20 is parallel to the axial direction.

In order that components such as a plurality of motors 21, a plurality of wheel train (train-of-wheels) mechanisms 23, a crown 25, the antenna 11, the transceiver 12, a solar panel 50 and a spacer 40 can be attached to, mounted on, stuck to, fixed to, supported by, held by or arranged on the main plate 20 to be fitted well, the main plate 20 has pins, protrusions, ribs, recesses, holes, notches, grooves, female screws and/or the like. A motor 22 of the plurality of motors 21 is connected to a wheel train mechanism 24 of the plurality of wheel train mechanisms 23, and the wheel train mechanism 24 is connected to the date indicator 60, so that the date indicator 60 is driven to rotate by the motor 22 and the wheel train mechanism 24. The other motors 21 and the other wheel train mechanisms 23 drive and rotate hands, such as a second hand, a minute hand, an hour hand and/or a function hand(s).

In order that the solar panel 50 and the spacer 40 can be arranged on the front of the main plate 20, the front of the main plate 20 is formed as follows.

The main plate 20 has a first convex part 31 at the outer circumference of the front of the main plate 20. The first convex part 31 is formed along the outer circumference of the front of the main plate 20. The first convex part 31 is cut in places at the outer circumference of the front of the main plate 20.

The main plate 20 has a plurality of second convex parts 32 on the front of the main plate 20. These second convex parts 32 are formed to be concentric arcs extending in the circumferential direction at positions radically inward from the first convex part 31.

The main plate 20 has a first arrangement face 33 on the front of the main plate 20. The first arrangement face 33 is oriented toward the crystal. The first arrangement face 33 extends in the circumferential direction between the first convex part 31 and the second convex parts 32. The first arrangement face 33 partly extends between the second convex parts 32 in the radial direction inward from the second convex parts 32, and those parts are referred to as extensions 34a, 34b. In this embodiment, the number of extensions 34a, 34b is two, but may be three or more, or may be one. One extension 34a and the other extension 34b are arranged substantially symmetrically with respect to the center of the main plate 20. More specifically, if areas/positions where the extensions 34a, 34b are formed are expressed in clock position, the extension 34a is formed in an area of one o'clock to two o'clock, and the extension 34b is formed at eight o'clock. The height position of the first arrangement face 33 is lower than the height position of the top of the first convex part 31. Therefore, the first convex part 31 protrudes from the first arrangement face 33, and accordingly a step is present between the first arrangement face 33 and the top of the first convex part 31. The height position of the first arrangement face 33 is also lower than the height position of the tops of the second convex parts 32. In the present disclosure, the height position refers to a position in the axial direction.

The main plate 20 has a second arrangement face 35 at the center of the front of the main plate 20. The second arrangement face 35 is, like the first arrangement face 33, oriented toward the crystal. Therefore, the second arrangement face 35 faces in the same direction as the first arrangement face 33 faces. The second arrangement face 35 spreads at a position radially inward from the first arrangement face 33. The height position of the second arrangement face 35 is higher than the height position of the first arrangement face 33, and accordingly a step is present between the second arrangement face 35 and the first arrangement face 33. The second convex parts 32 extend in the circumferential direction at the boundary between the first arrangement face 33 and the second arrangement face 35. The height position of the second arrangement face 35 is lower than the height position of the tops of the second convex parts 32. Therefore, the second convex parts 32 protrude from the second arrangement face 35, and accordingly a step is present between the second arrangement face 35 and the tops of the second convex parts 32.

The main plate 20 has a plurality of first markers 36 formed on the first arrangement face 33. The first markers 36 indicate adhesion positions of the strips of the double-sided adhesive tape 59 for fixing the solar panel 50 to the main plate 20. In this embodiment, the number of first markers 36 is two, but may be three or more, or may be one. The first markers 36 and the extensions 34a, 34b are alternately arranged in the circumferential direction. The first markers 36 are concave parts recessed in the first arrangement face 33. The first markers 36 are arc-shaped so as to extend in the circumferential direction on the first arrangement face 33. If areas where the first markers 36 are formed are expressed in clock position, one first marker 36 is formed in an area of five o'clock to seven o'clock, and the other first marker 36 is formed in an area of nine o'clock to eleven o'clock. Thus, since the first markers 36 are arranged substantially opposite one another on the front of the main plate 20, the solar panel is fixed thereto so as not to lift off. Since the first markers 36 are the concave parts recessed in the first arrangement face 33, the height position of the bottoms of the concave parts is lower than the height position of the first arrangement face 33, and accordingly a step is present between the bottoms of the concave parts and the first arrangement face 33.

The main plate 20 has a plurality of L-shaped second markers 37 formed on the first arrangement face 33. In this embodiment, the number of second markers 37 is three, but may be four or more, or may be two or less. If positions of the second markers 37 are expressed in clock position, one second marker 37 is arranged at two o'clock, another second marker 37 is arranged at seven o'clock, and the other second marker 37 is arranged at nine o'clock. The second markers 37, the antenna 11 and the transceiver 12 are arranged in the circumferential direction. In the case where the number of second markers 37 is three, namely, in this embodiment, the antenna 11, one second marker 37 (at two o'clock), the transceiver 12, another second marker 37 (at seven o'clock), and the other second marker 37 (at nine o'clock) are arranged in this order clockwise from the position of twelve o'clock, where the antenna 11 is arranged, so as to be apart from one another. The second marker 37 at two o'clock is arranged substantially opposite the second markers 37 at seven o'clock and nine o'clock with respect to the center of the main plate 20. The second markers 37 are concave parts recessed in the first arrangement face 33. The height position of the bottoms of the concave parts is lower than the height position of the first arrangement face 33, and accordingly a step is present between the bottoms of the concave parts and the first arrangement face 33. The depth of the second markers 37 is unequal to the depth of the first markers 36. In other words, the depth of the second markers 37 is greater than or less than the depth of the first markers 36. The depth of the second markers 37 may be equal to the depth of the first markers 36. The depth of the first markers 36 is the distance from the first arrangement face 33 to the bottom(s) of the first marker(s) 36. The depth of the second markers 37 is the distance from the first arrangement face 33 to the bottom(s) of the second marker(s) 37.

The second markers 37 may not be concave parts, but, for example, ink solidified films printed.

The positions and the shapes of the first convex part 31, the second convex parts 32, the first arrangement face 33, the second arrangement face 35, the first markers 36 and the second markers 37 are designed such that the solar panel 50, the spacer 40 and so forth can be arranged on the front of the main plate 20 so as to be fitted well.

### (3) Double-Sided Adhesive Tape

The double-sided adhesive tap 59 is a type of attaching component such as an adhesive or a sticky substance. The double-sided adhesive tape 59 may be referred to as double stick tape. In this embodiment, double-sided adhesive tape is used as the adhesive, but a liquid adhesive or a semi-hardened adhesive may be used in place of adhesive tape. The bottoms of the concave first markers 36 are each a first adhesion face to which the double-sided adhesive tape 59 is adhered, and the strips of the double-sided adhesive tape 59 are adhered to the bottoms of the concave first markers 36. The strips of the double-sided adhesive tape 59 are arc-shaped so as to extend in the circumferential direction between the first convex part 31 and the second convex parts 32. The thickness of the strips of the double-sided adhesive tape 59 is equal to or slightly greater than the depth of the first markers 36. The depth of the first markers 36 is the distance from the first arrangement face 33 to the bottom(s) of the first marker(s) 36. The thickness of the double-sided adhesive tape 59 is set such that the height position of the front face of the solar panel 50 fixed by the double-sided adhesive tape 59 is equal to the height position of the front face of the spacer 40.

### (4) Frame

The frame 45 is ring-shaped. The frame 45 is attached to the outer circumference part of the main plate 20.

### (5) Spacer

The spacer 40 is in the shape of a thin sheet. The spacer 40 is laid at the center of the front of the main plate 20. More specifically, the spacer 40 is placed on the second arrangement face 35 of the main plate 20. The front face of the spacer 40 is a face on which the date indicator maintaining plat 70, which will be described later, is placed. The spacer 40 may be fixed to the main plate 20 with glue, adhesive tape or screws. The spacer 40 may have holes into which convex parts formed on the front of the main plate 20 are fitted.

### (6) Solar Panel

The solar panel 50 is a ring-shaped thin-sheet-like component. The solar panel 50 is placed, around the spacer 40, on the first arrangement face 33 of the main plate 20. The solar panel 50 is fixed to the front of the main plate 20 by the double-sided adhesive tape 59 adhered to the solar panel 50. Since the double-sided adhesive tape 59 is adhered to the bottoms of the concave first markers 36, the thickness of the double-sided adhesive tape 59 does not cause bending deformation of the solar panel 50. The front face of the solar panel 50 has the same height position as that of the front face of the spacer 40, namely, is flush with the front face of the spacer 40.

The solar panel 50 has one or more photovoltaic elements that receive light and generate electromotive force. The solar panel 50 is electrically connected to the circuit board 10 via a contact or the like, and the electromotive force of the solar panel 50 is supplied to the circuit board 10, or a rechargeable battery is charged with the electromotive force.

The solar panel 50 has a plurality of sheet-like extensions 51a, 51b and an annular region 51c. The extensions 51a, 51b extend from the inner circumference of the annular region 51c inward in the radial direction. In this embodiment, the number of extensions 51a, 51b is two, but may be three or more, or may be one. One extension 51a (first extension) and the other extension 51b (second extension) are arranged substantially symmetrically with respect to the center(s) of the solar panel 50 and the main plate 20. More specifically, if positions of the extensions 51a, 51b are expressed in clock position, the extension 51a is arranged at one thirty, and the extension 51b is arranged at eight o'clock. The extension 51a is placed on the extension 34a of the first arrangement face 33, and the extension 51b is placed on the extension 34b of the first arrangement face 33. In the case where the number of extensions 51a, 51b is two and the number of first markers 36 is two, namely, in this embodiment, the extension 51a, one first marker 36 to which one strip of the double-sided adhesive tape 59 is adhered, the extension 51b, and the other first marker 36 to which the other strip of the double-sided adhesive tape 59 is adhered are arranged in this order clockwise from the position of twelve o'clock, where the antenna 111 is arranged.

The front face of each of the extensions 51a, 51b is a face on which the date indicator maintaining plate 70, which will be described later, is placed. On the back face of each of the extensions 51a, 51b, a terminal may be formed. The terminals are electrically connected to terminal pads of the circuit board 10 via conductors.

Since the second markers 37 are concave parts or ink solidified films, the second markers 37 do not cause bending deformation of the solar panel 50.

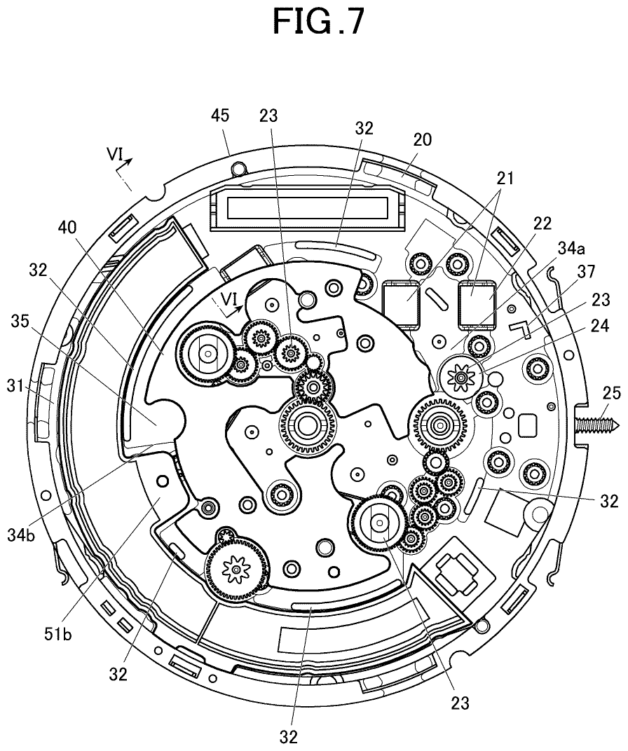

As shown in FIG. 7, the solar panel 50 may be in the shape of an arc like a ring a part of which is absent, namely, may be C-shaped, half-ring-shaped or the like. In this case, an arc-shaped sheet having a color very similar to that of the solar panel 50 may be arranged in the absent part to form a ring shape together with the arc-shaped solar panel 50. Further, in order to make the boundary(ies) between the arc-shaped solar panel 50 and the arc-shaped sheet inconspicuous, a ring-shaped light diffusion sheet may be laid on the front of the arc-shaped solar panel 50 and the arc-shaped sheet.

### (7) Date Indicator

The date indicator 60 is arranged above the solar panel 50 and accordingly lifts off from the solar panel 50. The date indicator 60 lifts off from the solar panel 50 by being supported by the second convex parts 32. Therefore, the date indicator 60 does not receive resistance force against the rotation of the date indicator 60 from the solar panel 50.

The date indicator 60 is made of a metal material, such as stainless steel or titanium alloy. The date indicator 60 has been subjected to character cutting, such as mechanical cutting, stamping, etching, laser beam cutting, sandblasting or water jet cutting. The metallic luster of the date indicator 60 provides the date indicator 60 with a sense of dignity and a sense of luxury. The character cutting provides the date indicator 60 with a three-dimensional appearance and a sense of luxury.

The date indicator 60 has an inner ring 61, an outer ring 62, a plurality of spokes 63, a plurality of openings 64, a plurality of character parts 65 and an internal gear 66. The inner ring 61 is arranged apart from the outer ring 62 inwardly, and the inner ring 61 and the outer ring 62 are concentric. The spokes 63 are arranged between the inner ring 61 and the outer ring 62 at intervals in the circumferential direction. These spokes 63 extend in the radial direction so as to build bridges from the inner ring 61 to the outer ring 62. The openings 64 are formed between the spokes 63 adjacent to one another. The openings 64 pass through the date indicator 60 from the front to the back. These openings 64 let sunlight pass through to reach the solar panel 50. The character parts 65 are arranged in the respective openings 64. The character parts 65 are connected to the inner ring 61, the outer ring 62 and/or the spokes 63 by thin links. The internal gear 66 is formed on the inner circumference of the inner ring 61. The internal gear 66 meshes with output gears of the wheel train mechanisms 23.

### (8) Date Indicator Maintaining Plate

The date indicator maintaining plate 70 is laid on the spacer 40. The date indicator maintaining plate 70 is disc-shaped. The outer circumference part of the date indicator maintaining plate 70 covers the internal gear 66 of the date indicator 60 from the side where the crystal is provided. The outer circumference part of the date indicator maintaining plate 70 is apart from or in soft contact with the internal gear 66. The soft contact means that the outer circumference part of the date indicator maintaining plate 70 is in contact with the internal gear 66 to the extent that the outer circumference part of the date indicator maintaining plate 70 hardly exerts resistance force against rotation on the date indicator 60.

The date indicator maintaining plate 70 goes beyond the edges of the spacer 40 and the second arrangement face 35 and projects toward the extensions 34a, 34b. This projecting part lifts off from the extensions 34a, 34b. The projecting part covers the extensions 51a, 51b of the solar panel 50 from the side where the crystal is provided and holds down the extensions 51a, 51b. As described above, since the front face of the solar panel 50 is flush with the front face of the spacer 40, the date indicator maintaining plate 70 does not wobble although it is laid on the spacer 40 and the extensions 51a, 51b of the solar panel 50.

### (9) Dial

The dial 80 is laid on the date indicator maintaining plate 70 and the date indicator 60. The dial 80 is supported by the date indicator maintaining plate 70, thereby being apart from the date indicator 60 toward the crystal. The dial 80 is made of a metal material or a resin material. The dial 80 is opaque. The dial 80 has a plurality of openings 81 arranged in the circumferential direction at positions radially outward from the (outer) circumference of the date indicator maintaining plate 70. The openings 81 pass through the dial 80 from the front to the back. These openings 81 let sunlight pass through to reach the date indicator 60 and the solar panel 50. The openings 81 are formed in the dial 80, which makes the dial 80 appear to be three-dimensional. The dial 80 may be transparent. In this case, the openings 81 may not be formed in the dial 80.

### 3. SECOND ELECTRONIC TIMEPIECE

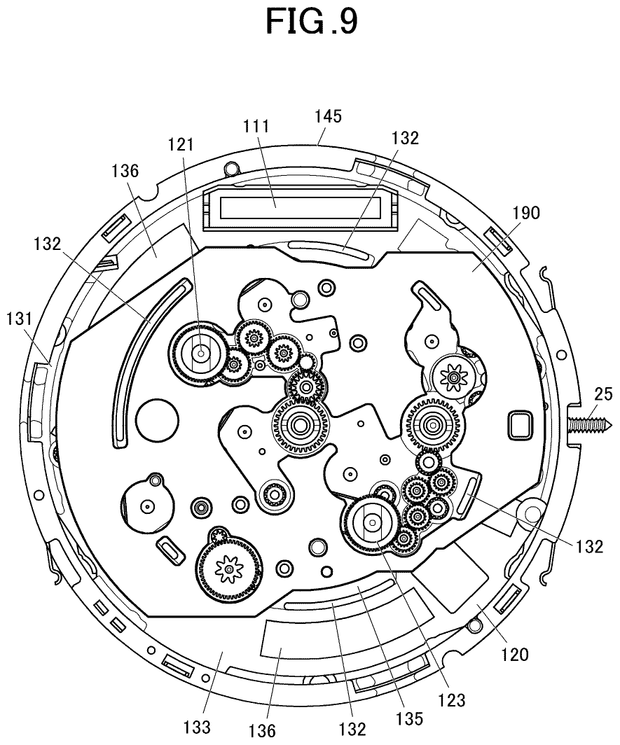

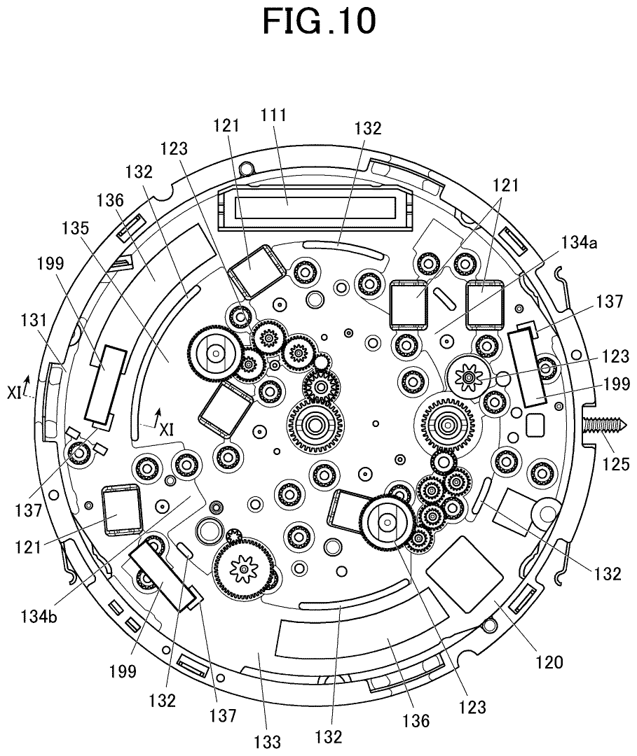

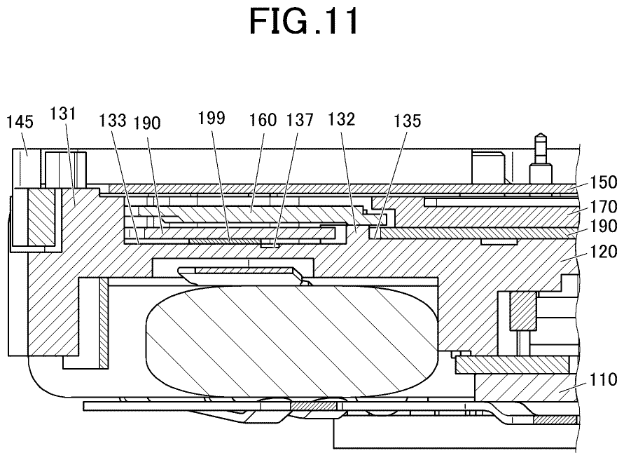

Like the electronic timepiece 1, the electronic timepiece 101 includes a case including a case body, a crystal and a back cover and a module including components shown in FIG. 8 housed in the case. Hereinafter the components of the module housed in the case of the electronic timepiece 101 will be described in detail with reference to FIG. 8 to FIG. 11. FIG. 9 and FIG. 10 are plan views showing the interior of the case. FIG. 9 and FIG. 10 are plan views as the electronic timepiece 101 is viewed in the direction from the crystal toward the back cover. FIG. 9 does not show a date indicator 160, a date indicator maintaining plate 170, a solar panel 150 and a dial 18 that are shown in FIG. 8. FIG. 10 does not show a magnetic shield plate 190 (sheet-like component, second sheet-like component) that is shown in FIG. 8 and FIG. 9, the date indicator 160, the date indicator maintaining plate 170, the solar panel 150 and the dial 180. FIG. 11 is a sectional view taken along line XI-XI shown in FIG. 10 as viewed in the arrow direction. The case of the electronic timepiece 101 may be the same as or different from the case of the electronic timepiece 1 in design.

The electronic timepiece 101 includes, in order from the back to the front, a circuit board 110, a main plate 120, the magnetic shield plate 190, the date indicator 160, the date indicator maintaining plate 170, the solar panel 150 and the dial 180 as the components of the module. The electronic timepiece 101 (module thereof) further includes a frame 145 and a plurality of strips of double-sided adhesive tape 199 (pieces of a second adhesive).

### (1) Circuit Board, Main Plate and Frame

The circuit board 110 of the electronic timepiece 101 is identical with the circuit board 10 of the electronic timepiece 1. The main plate 120 of the electronic timepiece 101 is identical with the main plate 20 of the electronic timepiece 1. The frame 145 of the electronic timepiece 101 is identical with the frame 45 of the electronic timepiece 1. The circuit board 110, the main plate 120 and the frame 145 are assembled as one unit in the electronic timepiece 101 in the same manner as the circuit board 10, the main plate 20 and the frame 45 are assembled as one unit in the electronic timepiece 1. As in the electronic timepiece 1, components such as a plurality of motors 121, a plurality of wheel train mechanisms 123 and a crown 125 are attached to, mounted on, stuck to, fixed to, supported by, held by or arranged on the main plate 120.

### (2) Magnetic Shield Plate

The magnetic shield plate 190 is in the shape of a thin sheet. The planar shape of the magnetic shield plate 190 is different from that of the solar panel 50 of the electronic timepiece 1. The thickness of the magnetic shield plate 190 is unequal to the thickness of the solar panel 50 of the electronic timepiece 1. More specifically, the magnetic shield plate 190 is thinner than the solar panel 50 of the electronic timepiece 1.

The magnetic shield plate 190 is made of a magnetism collecting material, such as cold-rolled steel or Permalloy. The magnetic shield plate 190 is laid at the center of the front of the main plate 120. More specifically, the magnetic shield plate 190 is placed on/above both the first arrangement face 133 and the second arrangement face 135 of the main plate 120. The magnetic shield plate 190 has a larger area than that of the spacer 40 of the electronic timepiece 1. The magnetic shield plate 190 goes beyond the edge of the second arrangement face 135 and projects toward the first arrangement face 133. Since the height position of the second arrangement face 135 is higher than the height position of the first arrangement face 133, the magnetic shield plate 190 lifts off from the first arrangement face 133.

The magnetic shield plate 190 covers the motors 121. The magnetic shield plate 190 magnetically shields the motors 121. The magnetic shield plate 190 has a horizontally-long, near-oval shape not to cover an antenna 111 and a transceiver 112 that are components for wireless communications, and is arranged so as to be off from the antenna 111 and the transceiver 112 in the plane direction. Therefore, the magnetic shield plate 190 does not magnetically shield the antenna 111 and the transceiver 112. In the present disclosure, the plane direction refers to the direction along a plane perpendicular to the axial direction.

Since the main plate 120 is the same as the main plate 20, a first convex part 131, second convex parts 132, the first arrangement face 133, extensions 134a, 134b, the second arrangement face 135, first markers 136 and second markers 137 are formed on the front of the main plate 120. Positions and shapes of the first convex part 131, the second convex parts 132, the first arrangement face 133, the second arrangement face 135, the first markers 136 and the second markers 137 are designed such that the magnetic shield plate 190 and so forth can be arranged on the front of the main plate 12 so as to be fitted well. If positions of the second markers 137 are expressed in clock position, one first marker 137 is arranged at two o'clock, another second marker 137 is arranged at seven o'clock, and the other second marker 137 is arranged at nine o'clock. The second markers 137, the antenna 111 and the transceiver 112 are arranged in the circumferential direction. In the case where the number of second markers 137 is three, namely, in this embodiment, the antenna 111, one second marker 137 (at two o'clock), the transceiver 112, another second marker 137 (at seven o'clock), and the other second marker 137 (at nine o'clock) are arranged in this order clockwise from the position of twelve o'clock, where the antenna 111 is arranged, so as to be apart from one another. The second marker 137 at two o'clock is arranged substantially opposite the second markers 137 at seven o'clock and nine o'clock with respect to the center of the main plate 20. Thus, since the second markers 137 (one second marker 137 and the other two second markers 137) are arranged substantially opposite one another on the front of the main plate 120, with the strips of the double-sided adhesive tape 199 the adhesion positions of which are specified by the second markers 137, the magnetic shield plate 190 adheres to the main plate 120, thereby being fixed to the main plate 120 so as not to lift off from the main plate 120. The double-sided adhesive tape 199 is a type of attaching component such as an adhesive or a sticky substance.

Some of the second convex parts 132 are fitted into holes formed in the magnetic shield plate 190. The second markers 137 indicate the adhesion positions at which the strips of the double-sided adhesive tape 199 adhere to the main plate 120, namely, the adhesion positions where the strips are adhered. The second marker 137 are L-shaped, and regions adjacent to the respective second markers 137 on the first arrangement face 133 (in particular, the L-shape inside corners of the respective second markers 137) are each a second adhesion face to which the double-sided adhesive tape 199 is adhered. Corners of the respective strips of the double-sided adhesive tape 199 are fitted with the L-shapes of the respective second markers 137, and the strips of the double-sided adhesive tape 199 are adhered to the respective second adhesion faces of the first arrangement face 133. The magnetic shield plate 190 adheres to the double-sided adhesive tape 199, thereby being fixed to the front of the main plate 120. The thickness of the double-sided adhesive tape 199 is equal to or slightly greater than the step present between the first arrangement face 133 and the second arrangement face 135. The thickness of the double-sided adhesive tape 199 is set such that the height from the first arrangement face 133 to the front of the magnetic shield plate 190 is equal to the height from the first arrangement face 33 to the front of the solar panel 50 of the electronic timepiece 1, and the double-sided adhesive tape 199 is thicker than the double-sided adhesive tape 59 of the electronic timepiece 1. The thickness of the double-sided adhesive tape 199 may be adjusted by thickening the adhesive or sticky layer of the double-sided adhesive tape 199. The same applies to the double-sided adhesive tape 59. The thickness of the double-sided adhesive tape 199 may be adjusted by thickening the base material of the double-sided adhesive tape 199. The same applies to the double-sided adhesive tape 59.

The thickness of the magnetic shield plate 190 is equal to the thickness of the spacer 40 of the electronic timepiece 1. The height from the first arrangement face 133 to the front of the magnetic shield plate 190 is equal to the height from the first arrangement face 33 to the front of the solar panel 50 of the electronic timepiece 1. Therefore, although the date indicator maintaining plate 170, which is the same as the date indicator maintaining plate 70 of the electronic timepiece 1, is laid on the magnetic shield plate 190, the date indicator maintaining plate 170, the solar panel 150 and the dial 180 are assembled without wobbling.

### (3) Date Indicator

The date indicator 160 is made of a metal material or a resin material. The date indicator 160 is ring-shaped. The date indicator 160 is transparent or opaque. The date indicator 160 has a plurality of characters printed, punched or engraved. The characters are arranged in the circumferential direction. The date indicator 160 has an internal gear on its inner circumference. The date indicator 160 is arranged above the magnetic shield plate 190 and accordingly lifts off from the magnetic shield plate 190. The date indicator 160 lifts off from the magnetic shield plate 190 by being supported by the second convex parts 132. Therefore, the date indicator 160 does not receive resistance force against the rotation of the date indicator 160 from the magnetic shield plate 190.

### (4) Date Indicator Maintaining Plate

The date indicator maintaining plate 170 is identical with the date indicator maintaining plate 70 of the electronic timepiece 1. The date indicator maintaining plate 170 is laid on the magnetic shield plate 190. The outer circumference part of the date indicator maintaining plate 170 covers the internal gear of the date indicator 160, and is apart from or in soft contact with the internal gear.

### (5) Solar Panel

The solar panel 150 is circular and thin-sheet-like. The solar panel 150 is laid on the date indicator maintaining plate 170 and the date indicator 160. The solar panel 150 is supported by the date indicator maintaining plate 170, thereby lifting off from the date indicator 160. The solar panel 150 has an opening 152 near its (outer) circumference. The opening 152 is arranged at four o'clock. The opening 152 exposes any one of the characters of the date indicator 160. The exposed character indicates the current date.

### (6) Dial

The dial 180 is made of a transparent or translucent material. The dial 180 is disc-shaped. The dial 180 is laid on the solar panel 150.

### 4. CONCLUSION

The main plate 20 of the electronic timepiece 1 has the first markers 36 and the second markers 37 on its front, and the main plate 120 of the electronic timepiece 101 has the first markers 136 and the second markers 137 on its front. In order to attach different components, namely, the solar panel 50 and the magnetic shield plate 190, to the main plate 20 and the main plate 120, respectively, the adhesion positions of the strips of the double-sided adhesive tape 59 and the adhesion positions of the strips of the double-sided adhesive tape 199 are specified by the first markers 36 and the second markers 137, respectively. Accordingly, where the solar panel 50 is fixed to the main plate 20 and where the magnetic shield plate 190 is fixed to the main plate 120 are specified by the first markers 36 and the second markers 137, respectively. Thus, the solar panel 50 and the magnetic shield plate 190, which are different from one another, can be properly attached to the main plate 20 and the main plate 120, which are identical with one another, respectively. Since the main plates 20, 120 of the modules of the electronic timepieces 1, 101 are shared components, the electronic timepieces 1, 101 as sister products are manufactured at low cost and an assortment of products is increased at low cost.

Suppose that the main plate 20 is different from the main plate 120. In other words, suppose that the main plate 20 has the first markers 36 but no second markers 37, whereas the main plate 120 has the second markers 137 but no first markers 136. In this case, the manufacturing facility, manufacturing process and so forth for the main plate 20 and those for the main plate 120 have unshared points. This leads to increase in production cost for mass production of the electronic timepiece 1 and the electronic timepiece 101. In this embodiment, the main plate 20 and the main plate 120 are identical, and therefore increase in production cost does not occur. In other words, the electronic timepieces 1, 101 as sister products are manufactured at low cost and an assortment of products is increased at low cost.

The back of the solar panel 50 adheres to the bottoms of the first markers 36 with the double-sided adhesive tape 59, so that the front face of the solar panel 50 is flush with the front face of the spacer 40. Therefore, the date indicator maintaining plate 70 does not wobble although it is laid on the spacer 40 and the extensions 51a, 51b of the solar panel 50.

Since the double-sided adhesive tape 59 is adhered to the bottoms of the first markers 36, the thickness of the double-sided adhesive tape 59 does not cause bending deformation of the solar panel 50. Therefore, the date indicator maintaining plate 70 does not wobble although it is laid on the solar panel 50.

The date indicator maintaining plate 70 goes beyond the edges of the spacer 40 and the second arrangement face 35 and projects toward the extensions 34a, 34b, and this projecting part covers the extensions 51a, 51b of the solar panel 50 from the side where the crystal is provided, and holds down the extensions 51a, 51b to the main plate 20. Therefore, the solar panel 50 is firmly attached to the main plate 20. Since the extensions 51a, 51b and the strips of the double-sided adhesive tape 59 are alternately arranged in the circumferential direction, the solar panel 50 is firmly attached to the main plate 20.

The magnetic shield plate 190 adheres to the first arrangement face 133 with the double-sided adhesive tape 199. The double-sided adhesive tape 199 supports, from underneath, the magnetic shield plate 190 that lifts off from the first arrangement face 133, thereby stabilizing the magnetic shield plate 190. The double-sided adhesive tape 199 contributes to prevention of wobbling of the magnetic shield plate 190.

The thickness of the spacer 40 of the electronic timepiece 1 is equal to the thickness of the magnetic shield plate 190 of the electronic timepiece 101. The thickness of the double-sided adhesive tape 59 and the thickness of the double-sided adhesive tape 199 contribute to making the height from the first arrangement face 133 to the front of the magnetic shield plate 190 of the electronic timepiece 101 equal to the height from the first arrangement face 33 to the front of the solar panel 50 of the electronic timepiece 1. Therefore, although the date indicator maintaining plate 170, which is the same as the date indicator maintaining plate 70 of the electronic timepiece 1, is laid on the magnetic shield plate 190, the date indicator maintaining plate 170, the solar panel 150 and the dial 180 are assembled without wobbling.

The magnetic shield plate 190 goes beyond the edge of the second arrangement face 135 and projects toward the first arrangement face 133. This projecting part covers the motors 121. The projecting part adheres to the first arrangement face 133 with the double-sided adhesive tape 199 near the motors 121. Therefore, the projecting part magnetically shields the motors 121 reliably.

The extensions 51a, 51b of the solar panel 50 are held down to the main plate 20 by the date indicator maintaining plate 70. Therefore, in order that the solar panel 50 can be fixed to the main plate 20 at parts other than the extensions 51a, 51b, the first markers 36 and the strips of the double-sided adhesive tape 59 need to be arranged so as to avoid the extensions 51a, 51b as shown in FIG. 2 to FIG. 5. If strips of double-sided adhesive tape are adhered to the front face of the main plate 20 using not the first markers 36 but the second markers 37 as indications (guides) or references and the solar panel 50 is fixed to the main plate 20 by the double-sided adhesive tape, since the double-sided adhesive tape and the second markers 37 are arranged near the extensions 51a, 51b, the solar panel 50 cannot be firmly fixed to the main plate 20 at the parts other than the extensions 51a, 51b. In other words, the second markers 37 cannot be used as the indications or references for the adhesion positions of strips of double-sided adhesive tape to fix the solar panel 50 to the main plate 20. Therefore, in this embodiment, separately from the second markers 37, the first markers 36 are formed in the area of five o'clock to seven o'clock and in the area of nine o'clock to eleven o'clock on the front face of the main plate 20, the strips of the double-sided adhesive tape 59 are adhered to the front face of the main plate 20 using the first markers 36 as the indications or references, and the solar panel 50 is firmly fixed to the main plate 20 by the double-sided adhesive tape 59.

Meanwhile, the magnetic shield plate 190 is arranged so as to avoid the antenna 111 and the transceiver 112 since the vertical dimension of the magnetic shield plate 190 is less than the horizontal dimension of the magnetic shield plate 190 as shown in FIG. 9, and the antenna 111 is arranged near one first marker 136 and the transceiver 112 is arranged under the other first marker 136 as shown in FIG. 10. Thus, the magnetic shield plate 190 does not overlap the first markers 136, or even if the magnetic shield plate 190 overlaps the first markers 136, their overlapped area is small. Therefore, even if strips of double-sided adhesive tape are adhered to the first markers 136, the magnetic shield plate 190 cannot be fixed to the main plate 120 by the double-sided adhesive tape. In other words, the first markers 136 cannot be used as the indications or references for the adhesion positions of strips of double-sided adhesive tape to fix the magnetic shield plate 190 to the main plate 120. Therefore, in this embodiment, separately from the first markers 136, the second markers 137 are formed at two o'clock, seven o'clock and nine o'clock on the front face of the main plate 120, the strips of the double-sided adhesive tape 199 are adhered to the front face of the main plate 120 using the second markers 137 as the indications or references, and the magnetic shield plate 190 is firmly fixed to the main plate 120 by the double-sided adhesive tape 199.

Although one or more embodiments have been described above, the technical scope of the present disclosure is not limited to the embodiments described above, but defined on the basis of claims. Further, the technical scope of the present disclosure includes the scope of equivalents with changes from the scope of claims added, the changes being irrelevant to the essence of the present disclosure.

1. A module comprising:
a plate; and
a sheet-like component that is fixed to the plate by an adhesive, the sheet-like component being a first sheet-like component or a second sheet-like component,
wherein the plate has:
a first marker indicating an adhesion position of a first adhesive for the first sheet-like component to be fixed to the plate, and
a second marker indicating an adhesion position of a second adhesive for the second sheet-like component to be fixed to the plate.

2. The module according to claim 1,
wherein the first marker is a concave part recessed in the plate, and
wherein a bottom of the concave part is a first adhesion face to which the first adhesive is adhered.

3. The module according to claim 2,
wherein the second marker is a concave part recessed in the plate or an ink solidified film printed on the plate, and
wherein a region adjacent to the second marker on the plate is a second adhesion face to which the second adhesive is adhered.

4. The module according to claim 3, wherein a height position of the first adhesion face is lower than a height position of the second adhesion face.

5. The module according to claim 1,
wherein the first sheet-like component is thicker than the second sheet-like component, and
wherein a piece of the first adhesive for the first sheet-like component to be fixed to the plate is thinner than a piece of the second adhesive for the second sheet-like component to be fixed to the plate.

6. The module according to claim 1, further comprising a communication component that is a transceiver or an antenna,
wherein the second marker is disposed apart from the communication component.

7. The module according to claim 6,
wherein the second sheet-like component is a magnetic shield plate, and
wherein the magnetic shield plate is fixed to the plate by the second adhesive, not covering the communication component.

8. The module according to claim 1, wherein the second marker includes a plurality of second markers, and a second marker of the plurality of second markers is disposed substantially opposite another second marker of the plurality of second markers.

9. The module according to claim 1, wherein the first sheet-like component is an annular or arc-shaped solar panel.

10. The module according to claim 1,
wherein the first sheet-like component has:
an annular region; and
a first extension and a second extension that extend from the annular region, are held down to the plate by a hold-down member, and are disposed apart from one another, and
wherein the first marker is disposed apart from the first extension and the second extension.

11. The module according to claim 1, wherein the first marker includes a plurality of first markers, and a first marker of the plurality of first markers is disposed substantially opposite another first marker of the plurality of first markers.

12. The module according to claim 1,
wherein a hold-down member is disposed on a spacer and the first sheet-like component that are disposed on the plate, and
wherein a face of the spacer and a face of the first sheet-like component are flush with one another, the faces being faces on which the hold-down member is disposed.

13. An electronic timepiece comprising the module according to claim 1.
